(19) United States
(12) Patent Application Publication
(10) Pub. No.: US 2003/0131245 A1
(43) Pub. Date: Jul. 10, 2003

(54) Communication security system

(76) Inventor: Michael Linderman, Ottawa (CA)

Correspondence Address: FISH & RICHARDSON PC, 225 FRANKLIN ST, BOSTON, MA, 02110, US

(21) Appl. No.: 10/337,180

(22) Filed: Jan. 6, 2003

Related U.S. Application Data
(60) Provisional application No. 60/345,695, filed on Jan. 4, 2002.
(60) Provisional application No. 60/423,086, filed on Nov. 1, 2002.

(51) Int. Cl. H04L 9/00

(52) U.S. Cl. 713/176

(57) ABSTRACT

An approach for secure application-to-application communication over the Internet uses a combination of application message interception, centralized policy management, and generic secure data connectivity layer for applications. Intercepting messages at an application layer enables use of application-specific security policies prior to the messages for different applications merging at lower levels of a communication protocol stack, and enables securing of the application messages as early as possible in the path to a peer application. The centralized policy management enables enforcement of security policies on multiple computers, both within and outside and enterprise network and protects against circumvention of security features specified by the policies. Data is transported between applications executing on different computers using a generic connectivity layer, which enables communication through firewalls that limit to particular ports and protocols, for example, allowing only HTTP-based communication on standard IP ports. Optionally, the approach complements VPN solutions by passing application-specific control information to VPN endpoints to enable those endpoints to perform application-specific processing while maintaining confidentiality of the application messages themselves.

### RELATED APPLICATIONS

This application claims the benefit of U.S. Provisional Application Serial No. 60/345,695 filed on Jan. 4, 2002 and of U.S. Provisional Application Serial No. 60/423,086 filed on Nov. 1, 2002, both of which are incorporated herein by reference in their entirety. This application is also related to U.S. application Ser. No. 09/900,041 filed on Jul. 9, 2001, and published on Mar. 14, 2002, as Publication No. 2002-0032790 A1, which is also incorporated herein by reference.

### BACKGROUND

The vulnerability of the Internet is becoming an ever more pressing problem. The number of reported incidents of violations of explicit or implied security policies has increased dramatically in the past few years. Increasing security incidents are causing IT departments to seek solutions for simple network operation and increased security.

Some approaches to securing communication have introduced security features directly into applications, for example, providing encrypted communication modes and enhanced user authentication in specially developed versions of applications.

Another commonly used approach to securing communication is to build virtual private networks (VPNs), in which communication between member of the virtual network is encrypted to prevent access by non-members. VPN based solutions generally handle all communication between members of the virtual network without consideration of the applications involved in the communication. SUMMARY

In a general aspect, the invention features an approach for secure application-to-application communication over the Internet that uses a combination of application message interception, centralized policy management, and generic secure data connectivity layer for applications. Intercepting messages at an application layer enables use of application-specific security policies prior to the messages for different applications merging at lower levels of a communication protocol stack, and enables securing of the application messages as early as possible in the path to a peer application. The centralized policy management enables enforcement of security policies on multiple computers, both within and outside and enterprise network and protects against circumvention of security features specified by the policies. Data is transported between applications executing on different computers using a generic connectivity layer, which enables communication through firewalls that limit to particular ports and protocols, for example, allowing only HTTP-based communication on standard IP ports. Optionally, the approach complements VPN solutions by passing application-specific control information to VPN endpoints to enable those endpoints to perform application-specific processing while maintaining confidentiality of the application messages themselves.

In one aspect, in general, the invention features a method for enforcing a security policy at multiple computers. The method includes accepting credentials from a first user at a first computer, receiving data characterizing a policy for use of the first computer by the first user, and mediating access between applications executed on the first computer and computing resources according to the received policy.

The method can include one or more of the following features:

The computing resources include resources hosted on remote computers, such as remote applications and remote file systems.

The computing resources include resources hosted locally on the first computer, such as a local file system.

A security module is provided on the first computer. The security module receives data characterizing the policy.

Communication between the applications and the resources is intercepted at the security module.

Communication between the applications and the computing resources is prevented without mediation using the security module.

Intercepting the communication includes binding operating system services with procedures implemented by the security module.

Binding operating system services includes binding input/output services.

Binding input/output services includes binding Windows Winsock services with procedures implemented by the security module.

The method includes authenticating the user based on the credentials.

Authenticating the user includes applying biometric authentication techniques.

The policy is provided to the first computer according the authentication of the user.

The method includes maintaining a database for policy data remote from the first computer, and providing the policy includes retrieving the policy from said database.

Receiving the policy includes verifying the authenticity of data representing the policy.

The received policy is cryptographically signed and verifying the authenticity data representing the policy includes verifying the cryptographic signature.

The received policy identifies an application to which it is applicable.

The received policy identifies a user activity to which it is applicable.

The received policy identifies computing resources to which it is applicable. The received policy identifies allowable actions to be performed in the mediated access.

Mediating access to the computing resources includes selectively encrypting communication between the applications and the computing resources.

Mediating access to the computing resources includes limiting access to the computing resources according to the received policy.

Limiting access to the computing resources includes prohibiting access to one or more of the computing resources.

The method includes receiving multiple policies, each identifying specific applications and computing resources such that different policies are associated with different combinations of applications and computing resources.

Mediating access to the computing resources includes accessing metadata associated with one of the computing resources, and restricting access to the resource according to the metadata.

The policy includes the metadata, which can be retrieved from a computer that is remote from the first computer.

Mediating access to computing resources local to the first computer by applications in communication with remote computing resources.

Mediating access to local computing resources includes restricting access to local files of the first computer.

The method further includes accepting credentials from the first user at a second computer, receiving the policy for that user at the second computer, and mediating access between applications executed on the first computer and computing resources that are remote from the first computer.

Aspects of the invention exhibit one or more of the following advantages:

Sensitive data can be automatically secured without user intervention.

Message security, virus protection, firewall and message format conversion are integrated to increase the degree of computer security as compared to independent solutions.

Operating systems, such as Microsoft Windows, can be hardened against access-based security threats such as unknown viruses.

The approach does not require use of a complex and expensive provisioning system.

Use of industry standards provides scalability and interoperability with other applications.

Existing programs are transparently extended with security features without requiring replacing or modifying existing programs.

Security policy enforcement is provided right at the desktop thereby increasing security.

Policy enforcement, file confidentiality, and communications confidentiality and integrity are all provided for existing applications, for both files and communications, on existing Windows platforms.

Secure communications is provided in an Extranet environment;

Costly, dedicated lines are substituted with low-cost Internet connections while at the same time profoundly increasing security.

Secure biometrics authentication and user signatures can be used for every message between applications.

Multiple different levels of encryption can be used for transmitted data.

Application-to-application security is provided in an n-tier application model no matter how many intermediaries are between them.

There is an advantage to having an application layer firewall installed on every computer, rather than a corporate firewall on a firewall server. Compromise or malfunction of the firewall server can affect many people inside the organization. Also, an application layer firewall can accommodate changes on individual computers more easily than on a server.

Custom VPN environments can be deployed in which only applications that are specifically designated are encrypted.

By capturing the application flow on the desktop and encrypting in memory before transmitting, data is truly protected from the source to destination.

Application based security is complimentary to common VPN solutions. Application layer VPN can be extended right to the desktop. Unlike traditional VPN technologies, only desired applications not the entire data connection need to be encrypted.

Virtually any off the shelf encryption scheme can be incorporated into the approach, creating no disruption when introduced to an existing environment.

Other features and advantages are apparent from the following description and from the claims.

### DESCRIPTION OF DRAWINGS

FIG. 1 is a network diagram.

FIG. 2 is a diagram that illustrates components of a client computer.

FIG. 3 is a software block diagram.

FIG. 4 is a diagram that illustrates application-to-application communication.

FIG. 5 is a block diagram that illustrates modules of a security layer.

FIG. 6 is a diagram that illustrates coordinated operation with a VPN device.

### DESCRIPTION

1 System Overview

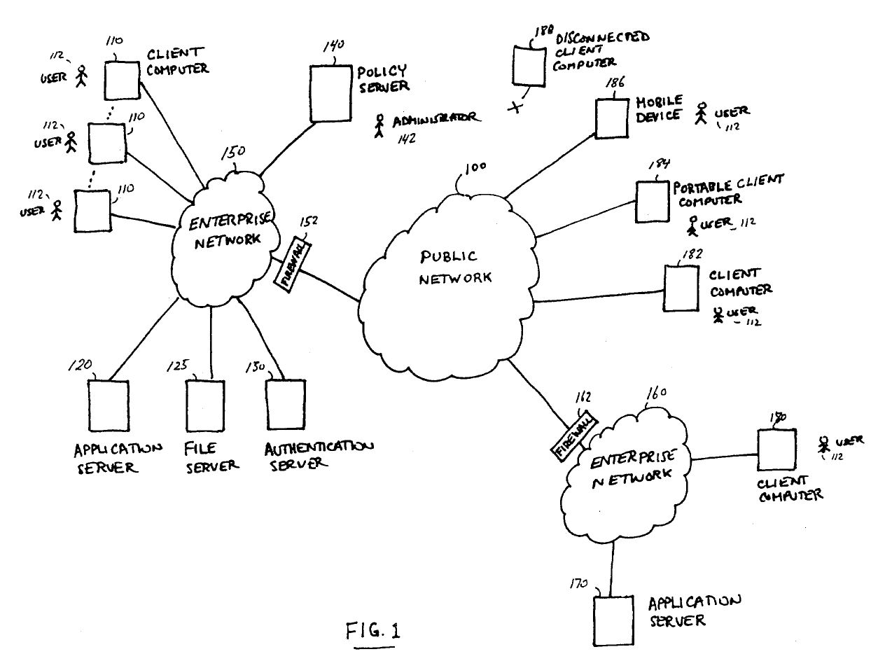

Referring to FIG. 1, a number of users 112 use client computers 110 communicate server computers 120-130, 170 over a system of interconnected data networks. The communication at each of the client computers is controlled by a security policy, which is specified by one or more administrators 142 at one or more policy servers 140. Each client computer includes security software that implements the security policy that has been specified for the user of the client computer and/or the client computer itself. As is described more fully below, the security software monitors activity of software applications (programs) executing on the client computer, including network communication and local data access activities, and intercepts data passed to or from the software applications during those activities. The security software then performs actions on the intercepted data according to the security policy including, for example, blocking the data because of a lack of authorization, encrypting/decrypting the data, or passing the data unmodified.

In an example configuration that is shown in FIG. 1, the client computers 110 are connected to an enterprise network 150. The enterprise network 150 is typically a geographically local network which has a degree of physical security. The enterprise network 150 typically includes a number of server computers. In the configuration shown in FIG. 1, these include an application server 120, a file server 125, and an authentication server 130. The application server 120 provides services such as web server and database server services. The policy server 140 is also connected to the enterprise network 150.

The administrator 142 is able to establish security policies that affect how users 112 at client computers 110 are permitted to access the server computers 120-130. As an example, some users may not be permitted to access certain of the server computers, or may be permitted to access the servers using only particular specified applications. Also, the security policy at a client computer can specify whether a particular application is permitted to store data on a local disk, and if so, whether such stored data must be encrypted.

In the example configuration shown in FIG. 1, the enterprise network 150 is connected to a public network 100. This public network is generally less secure than the enterprise network. The public network can include the public Internet, as well as other networks such as wireless data networks and cable television based data networks. A firewall 152 separates the enterprise network 150 and the public network 100. The firewall 152 is used to implement certain security features, such as blocking of communication to particular client and server computers on the enterprise network 150, blocking communication using particular communication ports, and detecting viruses in some communication such as in electronic mail messages. In addition to, or optionally instead of, the firewall functionality implemented in the firewall 152 itself, the security software in the client computers also implements firewall functionality to protect applications executing on those client computers.

In addition to client computers 110, other client computers 182-186 access servers 120-130 over the public network 100. These client computers also include security software to control how the users of those computers are able to communicate with server applications that are hosted at the server computers. These client computers can include a variety of types of client computers, including a client computer 182 that is configured to access the over the public network, a portable client computer 182 that is configured be connected at times directly to the enterprise network 150 and at other times connected to the enterprise network via the public network, and a mobile device 186 such as a cellular telephone that includes a browser (e.g., wireless application protocol, WAP) application.

A client computer 188 may also be disconnected from the enterprise network 150, for instance because of a communication failure or due to portable use of the computer in a remote location. The security software on the disconnected client computer continues to implement the security policy that has been loaded onto the client computer, for example, allowing access to encrypted data on the local storage of the disconnected client computer.

Client computers 110, 182-186 may also make use of an application server 170 on another enterprise network 160. For example, the enterprise networks 150 and 160 may be administered by different organizations that each maintain their own security policies. Similarly, a client computer 180 on the other enterprise network 160 may access server computers 120-130, which implement a security policy that determines how such remote clients are permitted to access server applications executing on those servers.

The security software on the client computers implements and authentication component that makes use of an authentication server 130 to authenticate the users of the client computers. Various forms of authentication are supported by the security software. including use of smartcards and biometric identification such as iris verification. For example, credentials can include a combination of a user's password and access to the user's smartcard that together are used to establish the user's identity. Security policies optionally specify the nature of a user authentication that is required to obtain access according to those policies. For example, certain security policies may require stronger forms of authentication, or require authentication that is certified by a particular certification authority.

2 Application Layer Security

2.1 Security Policies

As introduced above security policies are defined by one or more Security policy administrators. All security policies are digitally signed by a policy creator and only the policy creator or other authorized policy administrators may modify or delete a policy. A security administration policy identifies the authorized security administrators who can modify or delete existing policies or add new security policies.

A security policy include a number of attributes. These include: integrity attributes, subject attributes, object attributes, and actions. The integrity attributes include an identification of the policy administrator, the creator or owner of the policy, who is permitted modify the policy, and a digital signature by the policy administration to ensure integrity of the policy when it is distributed to client and server computers. The security software uses a public key infrastructure (PKI) to verify the integrity of security policies it receives.

The subject attributes of a policy includes one or more of a logon name, which is an identification of the user to who that the policy applies, a role of the user, an activity, which is a user-selected or automatically detected activity performed by the user (e.g., reading email), a software application (e.g., program name) that may be run by the user, and a state of the computer (e.g., online, offline).

A security policy can provide fine-grained control. The subject attribute of a policy may specify that it is applicable to a particular software application For example, a certain policy may be applicable to storage or communication activities associated with a program such as a particular web browser program. The subject attribute of a policy can also specify particular activities, such as reading email. The user explicitly selects and activity he wants to carry out, and security policies associated with that activity can block unrelated actions by an applications. For example, if an unknown virus attached to an email tries to access files that are not specifically permitted by a security policy for the email activity, then such file access would be blocked. Similarly, all attempts to modify executable files, including dynamically loaded libraries (DLLs), would be blocked during an email reading activity.

2.2 Software architecture

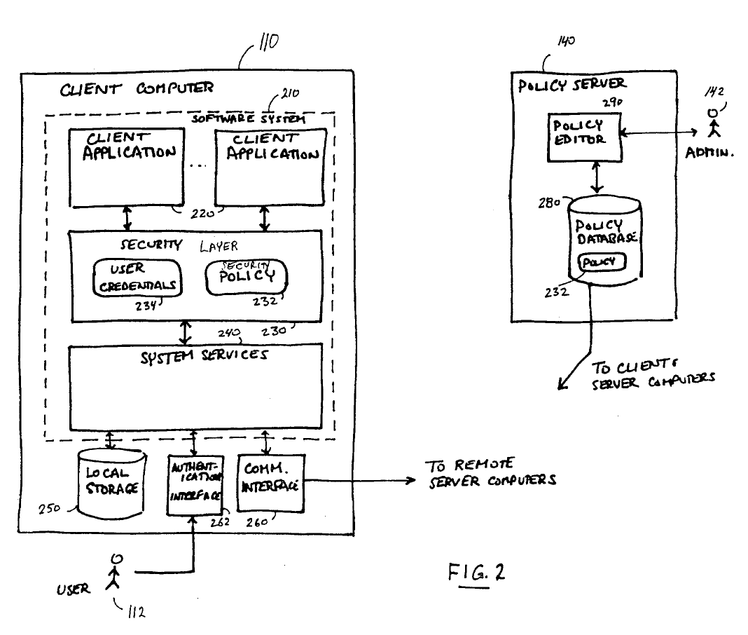

Referring to FIG. 2, a software system 210 that is hosted on a client computer 110 includes a number of client applications 220. The software system 210 includes a system services 240, which are provided by the operating system that controls execution of the client applications.

A security layer 230 couples the client applications 220 and the system services 240 such that data access and network communication messages are intercepted by the security layer as they are passed between the applications and the system services. The security layer holds user credentials 234 that are provided by the user 112, optionally using an authentication interface, such as a camera used for iris identification. The security layer also holds typically multiple security policies 232, which it obtains from the policy server 140. After authentication of the user credentials using the authentication server 130, the security layer uses appropriate ones of the security policies according to the identity of the authenticated user. The client computer 110 typically, but not necessarily, includes a local non-volatile storage 250, such as a magnetic disk. The security policy 232 can be stored in the local storage so that it does not have to be reloaded repeatedly from the policy server 140. Because the security policy is cryptographically signed, a malicious user cannot tamper with a security policy that is stored in the local storage to circumvent the provisions of the policy.

The security layer 230 intercepts network communication that passes into the client computer 110 through a communication interface 260, such as an Ethernet controller, and intercepts network communication passed from client applications 220 for transmission to remote computers through the communication interface.

The security layer 230 also intercepts data access (reading and writing) requests from applications to the local storage. A security policy may specify that particular data must be stored on the local storage in an encrypted form so that it cannot be accessed without mediation of the security layer on behalf of an authorized user and corresponding security policy that gives that user access.

The security layer 230 provides a coordinated set of intercepts and extensions that adds security policy enforcement to all existing applications. The security layer integrates seamlessly with legacy applications lacking security features and provides security for message transport over the public network, for example, by selectively introducing encryption on the message path.

When the security layer 230 intercepts activities such as file and network access, it evaluates the access according to the applicable security policy. For network communication policies, the outcome may be “not allowed”, “allowed-clear”, “allowed-secure”, or “ask the user.” The security administrator chooses which outcome is associated with the policy when the policy is created.

The policy server 140 provides centralized administration of a policy database 280, which includes multiple security policies 232 that have been authored by security administrators 142. Applicable policies are transferred from the policy server 140 to the client computers 110, where they may be stored in a local storage for later use. The security policies are signed by an administrator, or through a similar chain of authorities so that the security layer 230 can determine that it can trust the security policy.

Application and server computers also include a similar security layer, which are also controlled by security policies specified by the security administrators. Therefore, communication between a client computer and a server computer may be mediated by a security layers at one or both ends of a client/server connection.

2.3 Policy Editor

The policy editor allows a security administrator to create policies using various degrees of specificity in the attributes of the policy. For example, a policy may be applicable to a particular user, or may be applicable to a class of users defined by their role. Similarly, a data or communication resource that is protected by a policy may be specified by a particular name, such as a file name or a host name or address, or may also be specified by a class. For example, a pattern of file or host name, or a mask for host address may be specified. A policy is stored in a structured form using an XML syntax. The stored policy essentially specifies a rule that triggers when a particular combination of user, application, activity, and resource are present. In alternative embodiments, different specifications of such security policies or rules can be used.

2.4 Windows Architecture

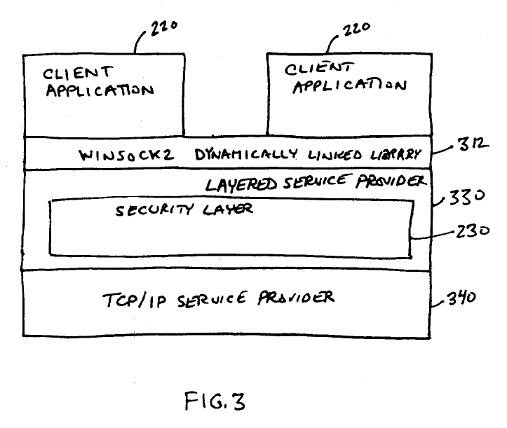

Referring to FIG. 3, an implementation of the software architecture shown in FIG. 2 under a Microsoft Windows operating system such as Windows 98, Windows NT, Windows 2000, Windows XP uses a layered service provider 330 to intercept network communication. Client applications 220 executing on the client computer make use of a Winsock2 dynamically-linked library (DLL) 312 that provides communication related services to the client applications. The client applications use a Winsock2 application-programming interface (API) to invoke functions in Winsock2 DLL 312. The layered service provider 330 implements a Winsock2 service provider interface (SPI). The security layer 230 is implemented within the layered service provider. The Winsock2 DLL 312 invokes the functions and services provided by the layered service provider using the Winsock2 SPI. The layered service provider then makes use of a Winsock2 SPI that is provided by a TCP/IP service provider 340 to access system services of lower level communication layers. As illustrated in FIG. 3, the client applications 220 make use of a standard Winsock2 API and therefore do not necessarily have to be modified to make use of the security layer 230.

A security layer is similarly implemented under other operating systems, including various versions of UNIX, thereby providing interoperability between different operating systems.

2.5 Operation

Under a Windows implementation, when an client application 220 seeks to establish a communication session with a server application at another computer, it invokes standard Winsock2 socket creation functions and does not necessarily know that security service provider is to be used. The layered service provider 330 intercepts the request to create a socket and passes the request to the security layer 230. The security layer applies the security policy (or policies) that is applicable to the application and the user and specified activity. If the policy specifies that communication with the server computer is to be protected and the server computer implements a similar security layer, the security layer at the client computer establishes a secure and authenticated communication session with the security layer at the server computer.

Depending on the configuration of the security layer and on the security policy, and optionally based on an initial dialog between the security layers at the two communicating computers, the secure communication session between the security layers at the two computers uses one of a number of different security protocols including SOAP Security Extension, SSL, PKI, or TLS. For example, control information may be passed between the security layers using SOAP, while the payload of the communication may use another approach, such as 3DES.

If possible, the two computers communicate directly. In one configuration of an application-to-application session, the security layers at the two computers use SOAP-based communication to pass control information related to the application communication. For example, this control communication establishes how the application data (“payload”) will be transferred, and transfers encryption keys and other information needed for secure communication of the payload. For reasons that may include communication efficiency, the payload of the communication may be transferred using a secure approach such as 3DES. For reasons that may include accessibility through firewalls, the payload may instead be transferred as part of a SOAP session.

In some configurations, the two computers cannot communicate directly, for example due to configuration of an intervening firewall. In such a situation, an approach described in U.S. application Ser. No. 09/900,041 (Publication No. 2002-0032790 A1) is used in which communication (control and payload) is passed from the client security layer to the server security via an intervening web server using SOAP-based communication. At the web server, a SOAP server forwards the communication to the server security layer, which ultimately passes the message payload to the server application.

Once the secure and authenticated communication session is established, the client and server applications send data over the session. The processing of the outbound data from the client computer is such that it is not buffered in its original state in a manner that leaves it accessible to other processes on the computer. Rather, relatively soon after the data is provided by application 210 to the security layer, it is secured thereby controlling access to it, even before it passes to the Internet. Inbound data on the communication session passes over essentially the reverse path of outbound data. The security layer receives the data from lower communication layers.

At a server computer, when a client application 220 attempts to establish a communication session to an application the layered service provider and its security layer intercept the inbound request. The security layer determines whether the requested communication session is to be established or should be rejected because the server application is not allowed to receive communication of this type.

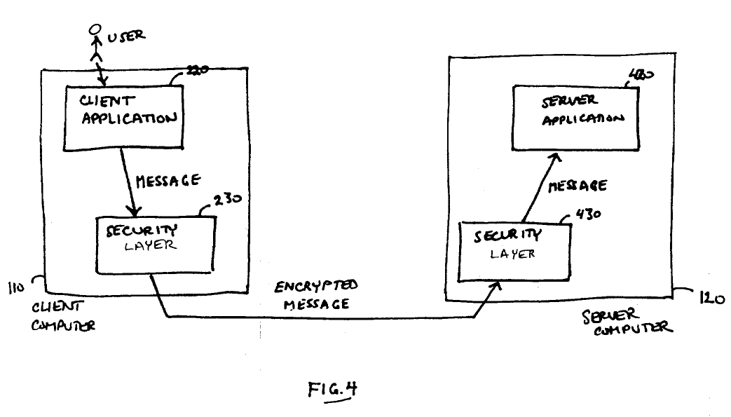

Referring to FIG. 4, communication between a client computer 110 and a server computer 120, both of which include security layers (230, 430), can occur according to a security policy that requires the communication to be encrypted. A client application 220 passes a message that is intercepted by the security layer 230. In this illustration, the security policy requires that the message be encrypted, which is performed by the security layer before it is passed to the server computer. At the server computer, the security layer 430 accepts the encrypted message, decrypts it, and as long as allowed by the server's security policies, provides the unencrypted message to the server application 420. In this scenario, the client and server applications do not have to be specifically configured to use encrypted communication.

In some scenarios, a server computer may not host a security layer but may provide standard data security capabilities. For example, in an email application, the security layer may intercept an email message destined for a recipient, and the security policy may require that the content of the message be encrypted using a standard technique, such as Secure Mime (S/MIME). In such a case, the security layer implements the encryption in a transparent manner even if the client email application is not configured for such encryption. Other examples of standard security capabilities use IPSec and Secure Socket Layer (SSL).

2.6 Security Layer modules

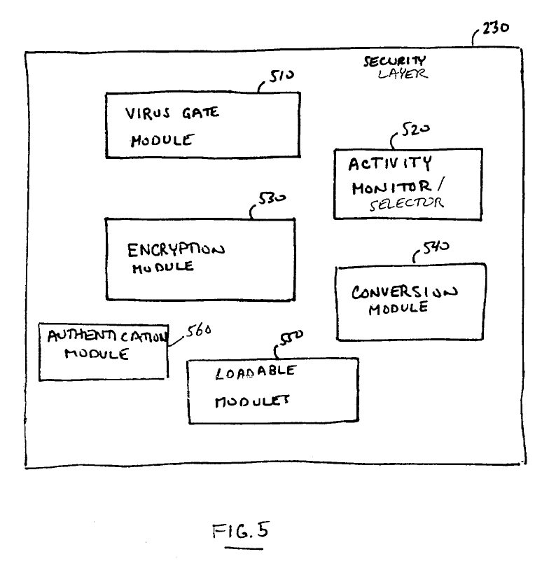

Referring to FIG. 5, the security layer 230 makes use of a number of interrelated modules. Furthermore, the security layer is extensible in that additional modules can be loaded to support processing needed by various security policies. Tile modules include a virus gate module 510, which provides virus protection and firewall services. An encryption module 530 implements encryptions services for protecting messages that are passed between computers or that are stored in the local storages of client or server computers. The security layer also includes provisions for format conversion, which is performed by a conversion module 540. An authentication module 560 interacts with an authentication server to authenticate a user. Additional loadable modules 550, such as additional encryption or virus protection modules are loadable into the security layer to implement security policies that require processing not provided for by the resident modules.

The security layer also includes an activity monitor/selector module 520, which monitors the activities performed by the user to determine the appropriate security policy to apply. This module determines whether a particular request, for example, a local file operation, belongs to an allowed activity. Note that an activity may require use of multiple applications, while some uses of one or more of those applications may fall outside the activity.

The approach also allows there to be multiple independent policy engines loaded into the application security layer, for example, each associated with different applications. Such an approach can be called a “federated” access control approach.

2.7 Anti-Circumvention

The security layer provides a number of protections to protect against attempts to circumvent the security policies implemented by the security layer. At a first level, if the security layer software is removed from a client computer, that computer can no longer interact with server computers that require the user authentication or encryption implemented by the security layer. That is, without the security layer software, the client computer has essentially the capabilities of a generic computer that never had the security layer installed on it.

In operation, the security layer protects persistent storage of data on the local storage of the computer. Therefore, once the volatile storage (e.g., RAM) of the client computer is lost, encrypted data on the local storage cannot be accessed without authorized use of the security layer. Therefore, attempting to copy files stored on the disk are ineffective. The security layer intercepts all file operations, and therefore, even cached files, can be encrypted according to a security policy and therefore inaccessible to an unauthorized person.

The security layer relies on the operating system for basic protection of volatile memory during operation. In order to harden the operating system, the security layer maintains data in an encrypted form for as long as possible. For example, the data for an application is decrypted on the fly during delivery to an application so that even if system buffers are compromised, the content is still secure. In operation, some of the security layer software executes in the address space of the application. To protect the messages while they are in system memory, the security layer encrypts and decrypts the messages in the application address space rather than with in system address space. This approach in combination with memory protection features of the host operating system increase the security of the messages. This approach is optionally used for inter-application communication within the same computer so that the data remains protected while it is buffered in a system buffer.

Offline operation of a client computer is permitted, as long as the security policies allow such operation. In order to provide for revocation of security policies, the policies are optionally specified to expire, or require periodic renewal by a policy server.

Attempts to subvert, intentionally or otherwise, the security layer may result in a denial of service. In interlocking web of active monitors optionally ensure that attempts to remove, disable, or otherwise subvert the policy enforcement component are audited. For instance, if the Winsock TCP/IP component is removed, TCP/IP applications cannot communicate. If the File 10 component is removed or disabled, the secured files remain encrypted.

3 Integration with VPN Infrastructure

The application-layer security features described above call be used in conjunction with virtual-private network (VPN) approaches. The application-to-application security can be thought of as a “virtual private session” which provides temporary secure connections between applications. As introduced above, one way of providing security on a channel between a client computer and a server computer is to use encryption and tunneling approaches that are also used in virtual private networks, for example, by incorporating VPN endpoint functionality into the security layer essentially forming VPN coupling the client and the server security layer software. Flows for different applications can be encrypted separately, and therefore, essentially, different applications or groups of application can participate in “virtual application networks”. This is in contrast to the flows for many different applications being combined and encrypted as a whole for transport over the VPN.

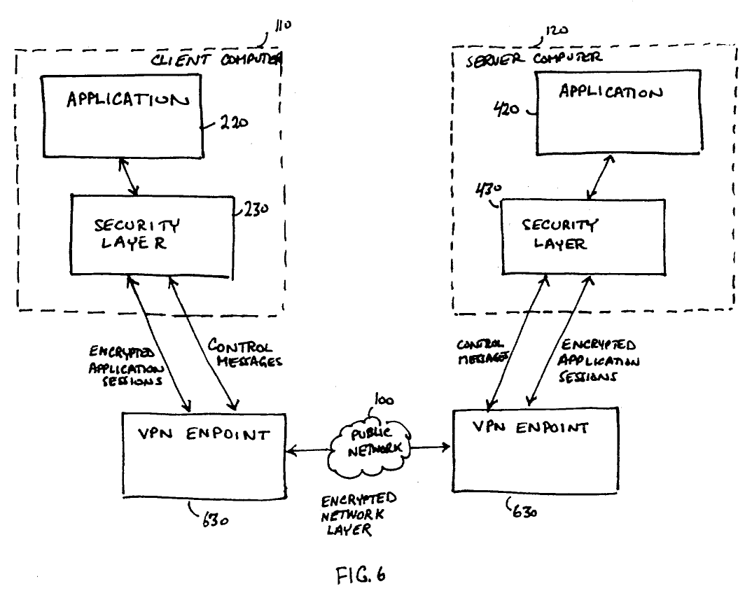

Referring to FIG. 6, in a related approach to use of VPNs, VPN-endpoint functionality is provided outside the security layer software, for instance in a dedicated computer or integrated into a network device such as a router or a switch. In this approach, the security layer intercepts application messages as described above, and selectively encrypts the application layer communication according to the applicable security policy. These messages are then forwarded through the standard communication protocol stack over the enterprise network to a VPN endpoint 630. The VPN endpoint 630, in general, receives communication from the client computer that is associated with a number of different applications. In order to enable application-specific processing of the communication, the security layer 230 passes control messages to the VPN endpoint 630, for example in a structured format (e.g., XML). These control messages allow the VPN endpoint to determine how to process the communication, allowing different virtual private sessions and virtual application networks to be handled differently by the network infrastructure. For example, different virtual application networks may have different security policies within the network, for example, at firewalls, and different virtual networks may have different priorities or service guarantees. In FIG. 6, communication between each security layer and the corresponding VPN endpoint may be encrypted and decrypted by the security layer. The communication passing over the public network 100 between the VPN endpoints 630 is then further encrypted and decrypted by the VPN endpoints.

In one version of this approach a router integrates the functionality of the VPN endpoint. For example, the router maintains a VPN tunnel to peer router for processing certain of its traffic. In such a router, application specific processing within the router may determine which traffic is to pass over the VPN based on network layer addressing as well as higher layer information, such as the application for which the communication is being passed. In addition to selection of VPN processing according to application-specific characteristics, the router may introduce quality of service processing. As a complement to functionality provided by the router, the security layer at the client computer performs certain security functions, such as encrypting data for specific applications, and then provide control information to the router to allow the router to make application and fine-grain activity based decisions without having to infer them from the stream itself, which may be difficult or impossible if the security layer has encrypted the content of the stream. For instance, the router can then determine which data should pass through a VPN or which data should receive a preference based on the control information.

In another version of the approach, the functionality of the VPN endpoint 630 is hosted on the same computer as hosts the application and security layer. Encryption and decryption by the security layer provides security without requiring tight integration with the VPN software, thereby allowing different VPN software to be used without necessarily having to be assured of the security of that software.

4 Distributed Firewall

Processing at the application security layer can also be used to distribute firewall processing based on a centrally-administered firewall policy. For example, instead of performing all firewall-related processing at a single entry point to all enterprise network, some functionally is implemented in the clients themselves in a way that prevents circumvention. For example, a security policy can be stored on a client computer specifying the address of the trusted e-mail server. Under such a policy, the client computer could be restricted to be able to send e-mail only via that trusted e-mail server. Furthermore, if the client computer is removed from behind a corporate firewall, for example, the firewall policy can remain in place.

The firewall functionality in the security layers of client and server computers optionally interacts with firewall functionality of a firewall device. For example, if a user is authorized to perform an activity that requires special communication to be allowed through the firewall device, the security layer requests that the firewall device allow such communication for a limited time while the user is authorized. In this way, security holes do not have to be left open in a firewall when they are no longer needed. An example of this type of communication is for multimedia conferencing using a product such as Microsoft Netmeeting. Today, many firewalls do not allow Netmeeting communication for security reasons. Using the application layer monitoring and policy-based authorization, Netmeeting communication is temporarily allowed for participants in a conference.

5 Alternatives

The application security layer approach can be used with applications that were developed without anticipating the use of such security functions. That is, legacy applications can be protected using the approach without necessarily modifying them to enforce security policies. A toolkit approach can alternatively be used for new applications in which security features and functionality are compiled in rather than residing lower in a communication protocol stack.

As described above, the security layer is hosted in client and server computers. An alternative is to have some or all of the functionality of the security layer hosted in a gateway device which essentially acts as a proxy for other computers. For example, a gateway device between the public network and an enterprise network can host such a proxy security layer, thereby securing communication over the public network which providing more limited security within the enterprise network. A security layer in a client computer and the security layer in a gateway device can act in tandem to provide increasing levels of protection as messages pass onto less secure networks. For example, the portion of the security layer in the client computer intercepts application messages in the application address space and securely forwards the messages with control information to the portion of the security layer that is hosted in the gateway device. Some of the functionality of the security layer, such as the functionality of the portion of the security layer associated with a gateway device, may also be hosted in devices such as routers, hubs, and modems.

The security layer optionally also performs monitoring functions to create a policy-based audit trail for certain types of operations.

What is claimed is:

1. A method for enforcing a security policy at computers comprising:
accepting credentials from a first user at a first computer;
receiving data characterizing a policy for use of the first computer by the first user; and
mediating access between applications executed on the first computer and computing resources according to the received policy.

2. The method of claim 1 wherein the computing resources include resources hosted on remote computers.

3. The method of claim 2 wherein mediating access to the computing resources includes mediating access to remote applications.

4. The method of claim 2 wherein mediating access to the computing resources includes mediating access to a remote file system.

5. The method of claim 1 wherein the computing resources include resources hosted locally on the first computer.

6. The method of claim 5 wherein mediating access to the computing resources includes mediating access to a local file system.

7. The method of claim 1 further comprising providing a security module on the first computer that receives data characterizing the policy.

8. The method of claim 7 wherein mediating the access between the applications and the computing resources includes intercepting communication between the applications and the resources at the security module.

9. The method of claim 8 further comprising preventing communication between the applications and the computing resources without mediation using the security module.

10. The method of claim 8 wherein intercepting communication includes binding operating system services with procedures implemented by the security module.

11. The method of claim 9 wherein binding operating system services includes binding input/output services.

12. The method of claim 11 wherein binding input/output services includes binding Windows Winsock services with procedures implemented by the security module.

13. The method of claim 1 further comprising authenticating the user based on the credentials.

14. The method of claim 13 wherein authenticating the user includes applying biometric authentication techniques.

15. The method of claim 13 further comprising providing the policy to the first computer according the authentication of the user

16. The method of claim 1 further comprising maintaining a database for policy data remote from the first computer, and providing the policy includes retrieving the policy from said database.

17. The method of claim 13 wherein receiving the policy includes verifying the authenticity of data representing the policy.

18. The method of claim 17 wherein the received policy is cryptographically signed and verifying the authenticity of the data representing the policy includes verifying the cryptographic signature.

19. The method of claim 1 wherein the received policy identifies an application to which it is applicable.

20. The method of claim 1 wherein the received policy identifies a user activity to which it is applicable.

21. The method of claim 1 wherein the received policy identifies computing resources to which it is applicable.

22. The method of claim 1 wherein the received policy identifies allowable actions to be performed in the mediated access.

23. The method of claim 1 wherein mediating access to the computing resources includes selectively encrypting communication between the applications and the computing resources.

24. The method of claim 1 wherein mediating access to the computing resources includes limiting access to the computing resources according to the received policy.

25. The method of claim 24 wherein limiting access to the computing resources includes prohibiting access to one or more of the computing resources.

26. The method of claim 1 further comprising receiving multiple policies, each identifying specific applications and computing resources such that different policies are associated with different combinations of applications and computing resources.

27. The method of claim 1 wherein mediating access to the computing resources includes accessing metadata associated with one of the computing resources, and restricting access to the resource according to the metadata.

28. The method of claim 27 wherein the policy comprises the metadata.

29. The method of claim 27 further comprising retrieving the metadata from a computer that is remote from the first computer.

30. The method of claim 1 further comprising mediating access to computing resources local to the first computer by applications in communication with remote computing resources.

31. The method of claim 30 wherein mediating access to local computing resources includes restricting access to local files of the first computer.

32. The method of claim 1 further comprising accepting credentials from the first user at a second computer, receiving the policy for that user at the second computer, and mediating access between applications executed on the first computer and computing resources that are remote from the first computer.

33. Software stored on a computer-readable medium comprising instructions for causing a computer system to perform functions comprising:
accepting credentials from a first user at a first computer;
receiving data characterizing a policy for use of the first computer by the first user; and
mediating access between applications executed on the first computer and computing resources according to the received policy.

34. A system for enforcing a security policy at computers comprising:
means for accepting credentials from a first user at a first computer;
means for receiving data characterizing a policy for use of the first computer by the first user; and
means for mediating access between applications executed on the first computer and computing resources according to the received policy.
